(19) United States
(12) Patent Application Publication
(10) Pub. No.: US 2005/0257035 A1
(43) Pub. Date: Nov. 17, 2005

(54) Linked instruction buffering of basic blocks for asynchronous predicted taken branches

(75) Inventors: Brian Robert Prasky, Wappingers Falls, NY (US); John Stephen Liptay, Rhinebeck, NY (US)

Correspondence Address: Richard M. Goldman, Suite 208, 371 Elan Village Lane, San Jose, CA, 95134, US

(73) Assignee: International Business Machines Corporation, Armonk, NY (US)

(21) Appl. No.: 10/844,299

(22) Filed: May 12, 2004

(51) Int. Cl. G06F 9/30

(52) U.S. Cl. 712/238

(57) ABSTRACT

A method and apparatus for providing the capability to create a dynamic based buffer structure that takes an instruction addresses organized instruction cache and through the interaction of an asynchronous branch target buffer (BTB) and branch history table (BHT) forms a series of instructions that resembles a trace cache in the buffer structure. By allowing the dynamic creation of a predicted code sequence trace in the buffer structure, based on the past behavior of the instruction code, the usage of fetching is utilized and the instruction cache makes optimal use of area while reducing latency penalties associated with taken branches and branches which are predicted in the improper direction.

### FIELD OF THE INVENTION

This invention relates to computer systems, and particularly to buffering of instruction text from the I-cache in relationship to dispatching of instruction from the buffer into instruction registers where the instructions are to be decoded.

### BACKGROUND OF THE INVENTION

There have been various methods proposed for buffering instruction text from the cache as a staging area in regard to the destination of the instruction registers where the instruction text is decoded; however, past solutions have not been completely optimized for space, utilization rates, and performance.

A basic pipeline microarchitecture of a microprocessor processes one instruction at a time. The basic dataflow for an instruction follows the steps of: instruction fetch, decode, address generation, cache access, register read, execute, and write back. Each stage within a pipeline or pipe occurs in order and hence a given stage can not progress unless the stage in front of it is progressing. In order to achieve the highest performance for the given base, one instruction will enter the decode phase of the pipeline every cycle. Whenever the pipeline has to be delayed or cleared, this adds latency which in turn can be monitored by the performance with which a microprocessor carries out a task. While there are many complexities that can be added on, this sets the groundwork for instruction fetching and branch prediction interaction.

If there are no branches in a pipeline then all instructions encountered are sequential in nature and the fetching required for such a pattern is a set of sequential fetch request to the instruction cache where the data that comes back from the cache is buffered and the appropriate number of instructions are dispatched to the instruction registers on each cycle. The instruction registers take in instructions and perform the decode operation. Decoding of instructions is the process of determining what process the given instruction is to carry out such that the rest of the pipeline can perform the given operation. Examples of what operation an instruction is to perform can vary from reading or writing instruction registers to reading or writing the data cache of a processor. Data that is acquired from a read process most likely will be operated on in some nature, including but not limited to adding and subtracting values, comparing values, and moving data around in storage. Given that operations are performed that require a decision, such as when a comparison takes place, the code that supports this must then go off in one of two directions based on the result of the compare. The two directions would be either a sequential path or a path to some other non-sequential instruction address known as a branch target. When going to a branch target, a new fetch must be made to acquire the instruction text at the target of the branch. At this point, this instruction text via the target address will also be buffered up. The purpose of buffering is that the latency that is involved with accessing a buffer is minimal compared to that of the cache.

There are many latency factors in a pipeline and the above are a few of the latency factors that are addressed within. When a branch is decoded, it can either be taken or not taken. A branch is an instruction which can either fall through to the next sequential instruction, not taken, or branch off to another instruction address, taken, and carries out execution of a different series of code. At decode time, the branch is detected, and must wait to be resolved in order to know the proper direction that the instruction stream is to proceed. By waiting for potentially multiple pipeline stages for the branch to resolve the direction to proceed, latency is added into the pipeline. To overcome the latency of waiting for the branch to resolve, the direction of the branch can be predicted such that the pipe begins decoding either down the taken or not taken path. At branch resolution time, the guessed direction is compared to the actual direction the branch was to take. If the actual direction and the guessed direction are the same, then the latency of waiting for the branch to resolve has been removed from the pipeline in this scenario. If the actual and predicted direction miscompare, then decoding proceeded down the improper path and all instructions in this path behind that of the improperly guessed direction of the branch must be flushed out of the pipe, and the pipe must be restarted at the correct instruction address to begin decoding the actual path of the given branch. Because of controls involved with flushing the pipe and beginning over, there is a penalty associated with the improper guess, and latency is added into the pipe over simply waiting for the branch to resolve before decoding further. By having a proportionally higher rate of correctly guessed paths, the ability to remove latency from the pipe by guessing the correct direction out weighs the latency added to the pipe for guessing the direction incorrectly.

In order to minimize latency between taken branches, those which do not take a sequential code stream path and the recovery of a branch which has gone in the improper direction at decode time, a buffer structure has been created such that the organization of the buffer is designed to hold the path of taken instructions. Through the interaction of a branch target buffer (BTB) interfacing with the buffer asynchronously as the buffer and instruction cache additionally interface asynchronously, the instructions placed into the buffer can be along the predicted code path. By creating a real time instruction address based cache to a trace buffer translation, the latency involved with placing a branch followed by the target of the branch through the given pipeline is removed as the target of the branch in regard to the instruction text is placed sequential after the branch from the buffer point of view. By placing the targets of predicted taken branches sequentially after the branches in the buffer, the dispatching of instructions from the instruction buffer to that of the instruction registers follow a defined stepping pattern.

In addition to removing latency of dispatching instructions from the buffer to the instruction registers, the placement of targets sequential after the branch eliminates buffer allocation of instructions that sequentially follow the branch but in the path that is not taken. Eliminating this excess buffer usage either allows for additional buffering on the processor to take place, or a smaller design which either reduces power or allows other beneficial logic to be placed in the given area to further aid the performance of the processor. The reduction of the amount of excess buffering creates the requirement that fetches made out to the instruction cache, to be placed into the buffer, are more likely to be required thereby improving the efficiency of the fetch request and therefore improving the overall performance of the processor.

As buffering depth is increased, the fetching logic can get further and further ahead of decode until the buffering becomes full. By allowing the buffering to get ahead of decode; when ever a fetch request is made to the first level of instruction cache, and a miss occurs as the data resides further out in memory, the buffer hides a portion or all of the required access time to make the fetch request beyond that of the level one cache by sending the acquired buffered instructions that are currently buffered and ahead of decode out to decode while the fetch request of a future concern is in progress.

A clear need exists for a compact buffering structure that interfaces with an asynchronous branch target buffer (BTB) and asynchronous dispatch control. A further need exists for an improved fetching algorithm that provides a trace cache buffering structure that is created dynamically, based on instruction transfer from an instruction address based instruction cache.

### SUMMARY OF THE INVENTION

The shortcomings of the prior art are overcome and additional advantages are provided through the provision of an instruction buffering structure that interacts asynchronously with an instruction address based instruction cache and branch target buffer (BTB) thereby buffering instruction in the instruction buffer in the pattern of the predicted code stream. This allows for a highly efficient fetching algorithm through preventing unnecessary fetching and the ability to decode the target of a branch the cycle after that of the decode of the branch while maintaining the ability to hide latencies associated with potentially multiple instruction cache misses with minimal logic.

This invention creates a compact buffering structure that interfaces with an asynchronous branch target buffer (BTB) and asynchronous dispatch control. Through such interactions, an improved fetching algorithm is plausible as essentially a trace cache buffering structure is created dynamically based on instruction transfer from an instruction address based instruction cache.

The invention described herein provides a method of defining a dynamic trace buffer structure. The buffer structure is situated between the instruction cache and instruction registers of a microprocessor and interfaces with an asynchronous branch target buffer (BTB) and branch history table (BHT). At a high level the method comprises dynamically altering the output of an index based structured instruction cache to create a buffer structure, and organizing instructions in the form of a trace cache.

The method further includes dividing the dynamic trace buffer structure into horizontal segments so that data return from the instruction cache fills buffer segments. In one embodiment this involves dividing the dynamic trace buffer structure into horizontal segments whereby each data return from the instruction cache fills a buffer segment. Typically, a segment acquires data from one of an instruction cache, a recovery buffer, or a vertical buffer above.

The dynamic trace buffer structure has a vertical direction of a depth at least one to as deep as deemed beneficial. A segment acquires data from the instruction cache, or a vertical buffer directly above the segment buffer.

According to our invention the dynamic trace buffer bidirectionally interacts with a recovery buffer, and the dynamic trace buffer gates sequential instruction text to the recovery buffer in the case of a predicted taken branch, where gating occurs before resolution. By this expedient, the instruction text for the correct code path is available immediately and is not fetched at the time frame of the detection of branch resolution. The recovery buffer gates an opposing and correct path of instruction text for a branch which was predicted in the improper direction.

The dynamic trace buffer structure interacts with the asynchronous branch target buffer (BTB) and the branch history table (BHT) prior to decoding of the instruction contained in the dynamic trace buffer structure. In this way, a branch is flagged in a buffer segment and the target is placed in the sequential buffer. One buffer segment is between the segment containing the beginning instruction text of a branch and the segment containing the instruction text of the target where the instruction length of the predicted starting location is unknown, whereby the branch to span the buffer it originates into the respected sequential buffer. A buffer segment contains at most a target of one branch and a future branch located at a point equivalent to either the instruction address or the later of the target of the first branch. In a preferred embodiment of the invention the dynamic trace buffer structure supports multiple branch and target combinations. More particularly, the dynamic trace buffer structure supports multiple branch and target combinations up to the number of buffer segments that are physically designed.

The method includes gating at least a single instruction from a main buffer into an instruction register. In a preferred embodiment, the method includes gating multiple instructions from the main buffers into instruction registers.

The method of our invention can initiate a fetch request for a given buffer segment and returns the instruction text to a different buffer segment if the buffer is being emptied via the decoding of instructions, branch resolution and the direction of the branch is the opposite of the direction guessed, or a branch is guessed taken which transfers buffer instruction data association from the main buffers to the recovery buffers.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of sequential trace buffer structure

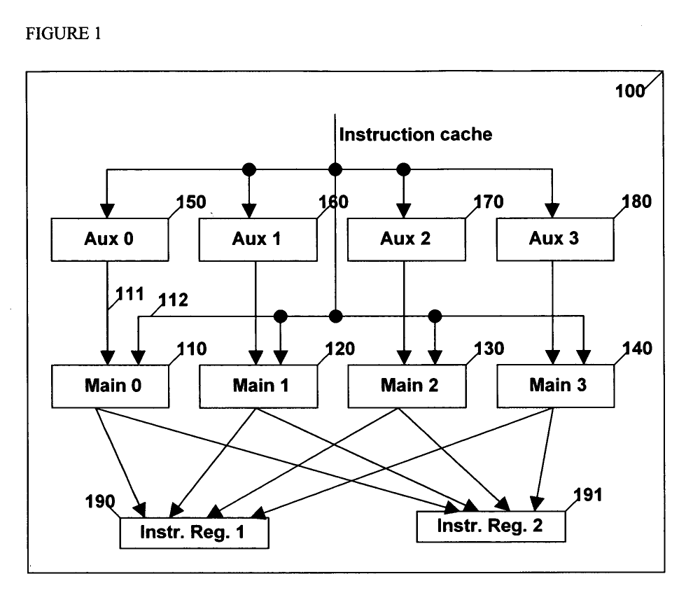

FIG. 2 illustrates one example of a microprocessor pipeline

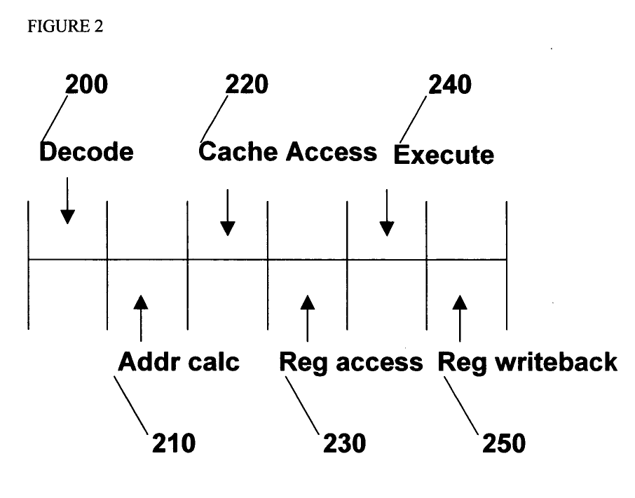

FIG. 3 illustrates one example of target of branch buffer placement

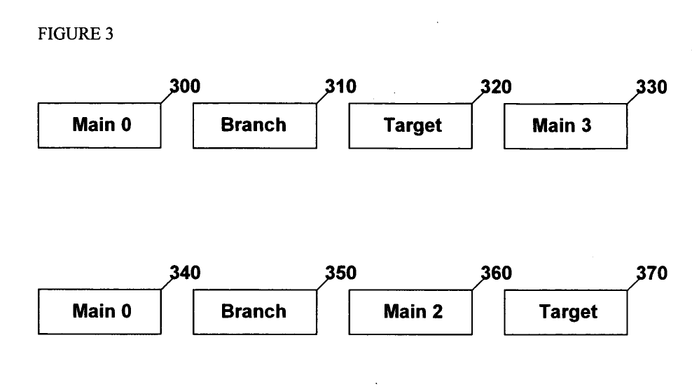

FIG. 4 illustrates one example of recovery buffer interaction

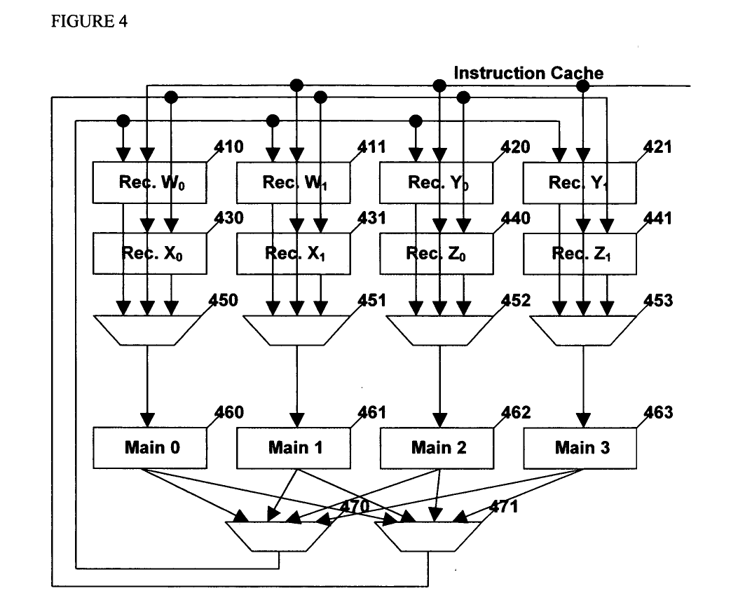

FIG. 5 illustrates one example of instruction register input data flow

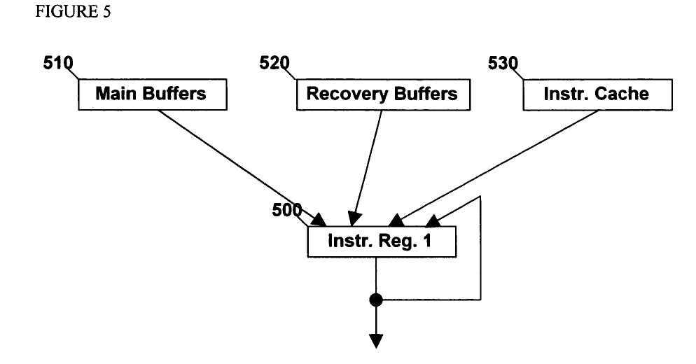

FIG. 6 illustrates one example of a BTB/BHT structure

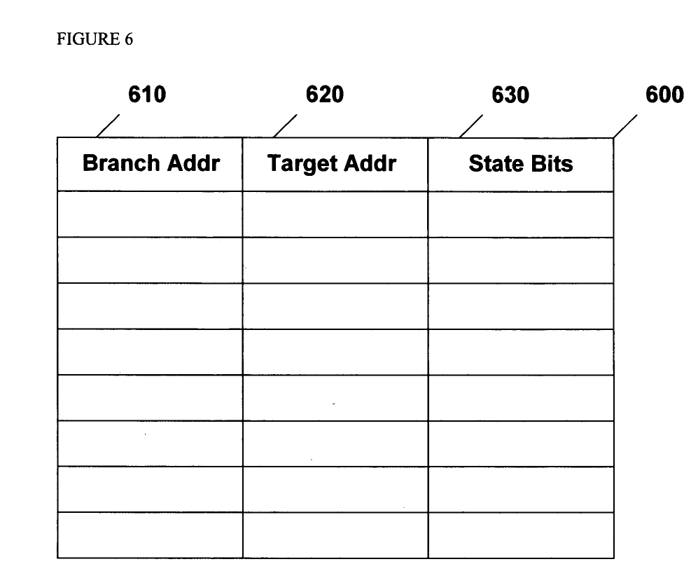

The detailed description explains the preferred embodiments of the invention, together with advantages and features, by way of example with reference to the drawings.

### DETAILED DESCRIPTION OF THE INVENTION

The present invention is directed to a method and apparatus in regard to the organizational and behavior of instruction fetching related to the return of the organization of data being placed into buffering situated between the cache and the instructions registers of a microprocessor pipeline given the interaction of an asynchronous branch target buffer and branch history table.

A basic pipeline can be described in 6 stages with the addition of instruction fetching in the front end. The first stage involves decoding 200 an instruction. During the decode time frame 200, the instruction is interpreted and the pipeline is prepared such that the operation of the given instruction can be carried out in future cycles. The second stage of the pipeline is calculating the address 210 for any decoded 200 instruction which needs to access the data or instruction cache. Upon calculating 210 any address required to access the cache, the cache is accessed 220 in the third cycle. During the fourth cycle 230, it is determined if the requested data was in the cache and if so, the data is transferred over to the execution unit. Furthermore, any registers needed for performing the logistics of an instruction is acquired at this time frame 230. Upon gathering the information, the instruction can be executed 240 during the fifth cycle. The results are then written back 250 during the sixth cycle.

When the pipeline is to decode 200, the instruction(s) in the instruction registers 190, 191, 500 to decode had to have come from some location. While the instruction cache 530 can potentially solely directly feed the instruction registers, ideally a higher bandwidth in respect to the width of the instruction registers is supported on the transfer of instructions from the instruction cache. The provided support to capture the data coming over 112 from the instruction cache is that of the instruction cache buffers. In the given organization, the instruction buffers are created in a two dimensional space. As shown as an example 100 of the two dimensional space, there are two rows of cache buffers. The lower row 110, 120, 130, 140 containing instruction text will be defined as the main buffers and the second row 150, 160, 170, 180 will be defined as the auxiliary buffers. For descriptive purposes, the data coming in will be the quantitative amount equivalent to the amount of data that can be stored in one of the eight buffers as depicted 100. When an instruction stream is started from a cold state, nothing is currently being processed in the processor, the first piece of data goes into buffer position 110. The following three sequential cache returns go into 120, 130, and 140. Upon filling up the main buffers, the next sequential instruction return from the cache will go into the auxiliary buffers, starting with 150, and then progressing to 160, 170, and 180.

When transitioning instruction text from the buffers to the instruction registers 190, 191, only the main buffers 110, 120, 130, 140 have the ability to transition instructions. By preventing all buffer allocations the ability to send instruction into the instruction registers, the amount of data muxing that is required to take place between the buffers and the instruction registers is minimized. By minimizing the amount of muxing that is required, it reduces the amount of logic that is required to perform the stated function. By requiring less logic, a shorter time frame is required to make the transition which can then allow the given dataflow to operate at a higher frequency. The main buffers work in a round robin fashion such that when instruction boundaries are not guaranteed to have boundaries at the main buffer segment boundaries, the instructions can be selected via the stitching of instruction text from two adjacent buffers. Such stitching would include buffer pairs: 110 with 120, 120 with 130, 130 with 140 and 140 with 110. When instruction text from a given buffer has been emptied, that is per say all of the required instruction text from the given buffer has been gated down to the instruction register, then the contents of the given buffer are no longer required and hence the buffer can be emptied. In the case where 110 contains the eldest instructions and these instruction have been completely gated down into the instruction register, then 110 can be emptied of its current contents. If data resides in the first auxiliary buffer 150, then the data within 150 is gated 111 into buffer 110 and a fetch request for the next serial segment of data in respect to 180 is made and upon the data returning from the instruction cache, the content is placed into position 150.

From a decode 200 perspective, if all instructions are not branches or they are branches but are not predicted taken, then decode 200 progresses in a sequential manner. In the case of a taken branch at decode 200 time, if there is no associated asynchronous prediction for the given branch, then the target must be computed via the address calculation 210 such that a fetch request can be made to the cache for the given target address. The data will then return from the cache 230 and be placed into the buffers after the instruction cache has been read 220. In this pattern of operation, there is a penalty associated with any time that a branch is decoded and guessed taken as the processor encounters latency as the instruction text for the target of the branch is being acquired. The usage of branch prediction array 600 with logic via a branch target buffer (BTB) 610, 620 and a branch history table (BHT) 630 can resolve the majority of times when such latency is added into the pipeline. Upon starting off from a cold position, when the first instruction is fetched for a given address, the BTB and BHT start searching for the address of the last known taken branch. Upon locating such a branch, a given buffer 310 for the instruction text is tagged as having the branch. Given that the stated buffer has a predicted taken branch in its locality, then any future instructions beyond this point 320, 330 are not sequentially required. Therefore, the fetching algorithm will begin fetching for the target of the predicted branch and place the initial target fetch contents in buffer 320. Any buffers prior 300 to the branch up to the branch 310 are not altered in respect to instruction text. If instruction boundaries are not guaranteed to fall on buffer boundaries where a buffer can always hold multiple instructions, then it is possible that an instruction can span buffers 350, 360. In the scenarios where it is possible for an instruction to span a buffer boundary and the branch prediction is unaware of an actual spanning when the potential exist, the branch buffer 350 will be flagged in the same manner; however, the target will be placed in the following buffer 370. Doing such prevents any predicted instruction path from over writing a required sequential stream of valid instruction text. Once again, any buffers 340 prior to the branch up to the branch 350 are not altered in respect to instruction text.

In general the width of the buffer structure is determined from a required width needed to support gating of instructions to the instruction registers 190, 191 (more is better) along with the amount of mux selection, of the buffers, that meets cycle time (less is better). The height of the buffer structure is determined by the total amount of buffering of instructions that is required for optimal performance.

When a branch, via a branch address, 610 is predicted to exist in a given buffer, this will be the predicted path that is sent through the pipeline. At execution time 240, the resolution of the branch will be determined to be taken or not taken which will either agree or disagree with the given prediction. If the prediction agrees with the resolution then the main and aux buffers continue to progress in the current forward direction. If the branch resolution disagrees with the prediction then the main 110, 120, 130, 140 and auxiliary 150, 160, 170, 180 buffers must be cleared out as the recovery path will restart the stated buffers. The recovery path 410, 411 or 420, 421 or 430, 431 or 440, 441 is the opposing path to the guessed direction of the branch. Hence, if the branch is guessed taken, the recovery path is the not taken direction. If the branch is guessed not taken, the recovery path is the taken direction.

Gating of instructions into the main 110/460, 120/461 or 130/462, 140/463 buffers in the case of a branch that was guessed one way and resolves another is a two step process. The first step is preparing what is to be gated into the recovery buffers for a branch wrong and the second step is gating the content into the main buffer structure in the occurrence of a branch wrong. The storage of instruction text down the non-predicted path is handled via recovery buffers: 410/411, 420/421, 430/431, 440/441. In the provided example there are four pairs of recovery buffers. In the case that a branch is encountered in the instruction registers 190, 191, 500 that is not taken, then fetching takes place for the taken path via the calculation 210 of the target address and the returned instruction text from the instruction cache is placed in one of the recovery buffer pairs, i.e. 410 of 410 and 411. When a surprise branch i.e. 460 is decoded in the instruction registers 190, 191, 500 that was not predicted via the branch prediction logic, and it guessed taken, the two sequential buffers i.e. 460/461 or 462/463 that represent the instructions after that of the surprise taken branch are moved 470, 471 into the first pair of recovery buffers 520 and the main/aux buffers 510 are cleared. A fetch is made for the target at the target address and the instruction text that is related to the target address fetch from the cache begins to fill up the main/aux buffers beginning at the first main buffer 110, 460. The third of the three potential cases is when a branch is predicted, via asynchronous prediction, to occur in one of the main/aux buffers. When this occurs, the movement of data from the main/aux buffers to the recovery buffers has the option of being transferred into the recovery buffers 410, 411 or 420, 421 or 430, 431 or 440, 441 at one of two time frames. If the movement takes place when the prediction of a branch location is deemed, those buffers that represent buffering positions for sequential instructions following the branch buffer(s) are cleared. The buffer that is to contain the instruction text content of the sequential instructions following the branch i.e. 350, 360 of the given buffers if available is moved into the first pair of available recovery buffers i.e. 410, 411. The second pattern for movement can be such that the buffers related to the target buffer i.e. 320 used in regard to the branch i.e. 310 and those that follow sequentially i.e. 330 are cleared, but nothing is moved into recovery at this time. Upon decoding 200 of the given branch, any remaining sequential instruction text within that buffer of the one sequential buffer 310, or should the branch potential span two buffers 350, 360 is moved into the first available recovery buffer i.e. 410, 411. Through the movement of data into the recovery buffer 520 at the earlier time frame, more data is likely to be available for moving, as it has yet to be cleared; however, this also creates a longer time span between the stated point and that of branch resolution. Because of the longer time frame, additional recovery buffer sets are required to provide support for providing performance requirements of keeping track of the number of branches within the pipeline between these two points. If the recovery buffer 520 is started at decode time frame 200, then there is likely to be less instruction text to move to recovery thereby potentially creating the need to perform an addition fetch request to the instruction cache. While additional fetching may be required, the later movement states that there are on average less branches in the pipe because of working with a shorter portion of the pipeline. Given that there are less branches within the pipeline segment of concern, less recovery buffers are needed to support the throughput performance of the pipeline.

The structure of the recovery buffers 520 is to provide the ability to decode 200 immediately after a branch wrong as the instruction text for the opposing path is not required to be fetched again from the instruction cache 530 as it has already been fetched ahead of time and is currently waiting in a buffer 520. The relationship of the recovery buffers to the main buffers is such that half of the recovery buffers 410, 411, 430, 431 gate 450, 451 into the first two main buffers 460, 461, while the other half of recovery buffers 420, 421, 440, 441 gate 452, 453 into the other two main buffers 462, 463. By creating a split of where the recovery buffers are gated to, it balances out the recovery gating structure into the main buffers. By creating a balanced design, load characteristics remain equivalent across the main buffers 460, 461, 462, 463 thereby creating equal equivalent paths in respect to timing. If the paths are not balanced out, then one side can potentially operate at a higher frequency and the other side one run at a slower frequency. The overall frequency of the machine is determined via the slowest path; thereby causing such an unbalanced design to be slower.

The number of recovery buffers is chosen as to match the throughput of the pipeline of the processor. Given that recovery buffers may be used at the time a prediction is placed into the main/aux buffer structure which occurs prior to decode 200 or at a time respective to decode, there are many stages prior to the resolution of the given branch at execution 240 time frame. Because of the distance between branches using recovery buffers and the time a branch is resolved, there can be a number of branches in the pipeline of the processor at any given time. Because multiple branches can be in the pipeline at a given time frame, multiple recovery buffers 410/411, 420/421, 430/431, 440/441 are needed as each occurrence of a branch in the pipeline requires the usage of a recovery buffer. In the given example there are four recovery buffer pairs and therefore up to four branches in the pipeline can be supported at any time.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method of defining a dynamic trace buffer structure, said buffer structure situated between the instruction cache and instruction registers of a microprocessor and interfacing with an asynchronous branch target buffer (BTB) and branch history table (BHT) comprising dynamically altering the output of an index based structured instruction cache to create a buffer structure, and organize instructions in the form of a trace cache.

2. A method as defined in claim 1 comprising dividing the dynamic trace buffer structure into horizontal segments whereby data return from the instruction cache fill buffer segments.

3. A method as defined in claim 2 comprising dividing the dynamic trace buffer structure into horizontal segments whereby each data return from the instruction cache fills a buffer segment.

4. A method as defined in claim 2 wherein a segment acquires data from one of an instruction cache, a recovery buffer, or a vertical buffer above.

5. A method as defined in claim 1 wherein the dynamic trace buffer structure has a vertical direction of a depth at least one layer.

6. A method as defined in claim 5 wherein a segment acquires data from the instruction cache, or a vertical buffer directly above the instruction cache.

7. A method as defined in claim 1 wherein the dynamic trace buffer bidirectionally interacts with a recovery buffer.

8. A method as defined in claim 7 wherein the dynamic trace buffer gates sequential instruction text to the recovery buffer in the case of a predicted taken branch.

9. A method as defined in claim 8 wherein instruction text for the correct code path is available immediately and is not fetched at the time frame of the detection of branch resolution.

10. A method as defined in claim 8 wherein the recovery buffer gates an opposing and correct path of instruction text for a branch which was predicted in the improper direction.

11. A method as defined in claim 1 wherein the dynamic trace buffer structure interacts with the asynchronous branch target buffer (BTB) and the branch history table (BHT) whereby prior to decoding of the instruction contained in the dynamic trace buffer structure, a branch is flagged in a buffer segment and the target is placed in the sequential buffer.

12. A method as defined in claim 11 wherein one buffer segment is between the segment containing the beginning instruction text of a branch and the segment containing the instruction text of the target where the instruction length of the predicted starting location is unknown, whereby the branch to span the buffer it originates into the respected sequential buffer.

13. A method as defined in claim 11 wherein a segment contains at most a target of one branch and a future branch located at a point equivalent to either the instruction address or the later of the target of the first branch.

14. A method as defined in claim 11 wherein the dynamic trace buffer structure supports multiple branch and target combinations.

15. A method as defined in claim 14 wherein the dynamic trace buffer structure supports multiple branch and target combinations up to the number of buffer segments that are physically designed.

16. A method as defined in claim 1 comprising gating at least a single instruction from a main buffer into an instruction register.

17. A method as defined in claim 16 comprising gating multiple instructions from the main buffers into instruction registers.

18. A method as defined in claim 1 comprising initiating a fetch request for a given buffer segment and returning the instruction text to a different buffer segment if the buffer is being emptied via the decoding of instructions, branch resolution where the direction of the branch is the opposite of the direction guessed, or a branch is guessed taken which transfers buffer instruction data association from the main buffers to the recovery buffers.

19. A computer system having a microprocessor having an instruction cache and instruction registers, wherein the buffer structure is situated between the instruction cache and instruction registers, and interfaces with an asynchronous branch target buffer (BTB) and branch history table (BHT), said computer system configured and controlled to define to dynamically alter the output of an index based structured instruction cache to create a buffer structure, and to organize instructions in the form of a trace cache.

20. A computer system as defined in claim 19 wherein the dynamic trace buffer structure comprises horizontal segments whereby data return from the instruction cache fill buffer segments.

21. A computer system as defined in claim 20 wherein the dynamic trace buffer structure comprises horizontal segments whereby each data return from the instruction cache fills a buffer segment.

22. A computer system as defined in claim 20 wherein a segment acquires data from one of an instruction cache, a recovery buffer, or a vertical buffer above.

23. A computer system as defined in claim 19 wherein the dynamic trace buffer structure has a vertical direction of a depth at least one layer

24. A computer system as defined in claim 23 wherein a segment is adapted to acquire data from the instruction cache, or a vertical buffer directly above the instruction cache.

25. A computer system as defined in claim 19 wherein the dynamic trace buffer bidirectionally interacts with a recovery buffer.

26. A computer system as defined in claim 25 wherein the dynamic trace buffer is adapted to gate sequential instruction text to the recovery buffer in the case of a predicted taken branch.

27. A computer system as defined in claim 19 wherein the dynamic trace buffer structure is adapted to interact with the asynchronous branch target buffer (BTB) and the branch history table (BHT) whereby prior to decoding of the instruction contained in the dynamic trace buffer structure, a branch is flagged in a buffer segment and the target is placed in the sequential buffer.

28. A computer system as defined in claim 27 wherein one buffer segment is between the segment containing the beginning instruction text of a branch and the segment containing the instruction text of the target where the instruction length of the predicted starting location is unknown, whereby the branch to span the buffer it originates into the respected sequential buffer.

29. A computer system as defined in claim 27 wherein a buffer segment is adapted to contain at most a target of one branch and a future branch located at a point equivalent to either the instruction address or the later of the target of the first branch.

30. A computer system as defined in claim 27 wherein the dynamic trace buffer structure supports multiple branch and target combinations.

31. A computer system as defined in claim 30 wherein the dynamic trace buffer structure supports multiple branch and target combinations up to the number of buffer segments that are physically designed.

32. A computer system as defined in claim 19 wherein a gate is adapted to gate at least a single instruction from a main buffer into an instruction register.

33. A computer system as defined in claim 32 wherein the gate is adapted to gate multiple instructions from the main buffers into instruction registers.

34. A computer system as defined in claim 19 adapted to initiate a fetch request for a given buffer segment and returning the instruction text to a different buffer segment if the buffer is being emptied via the decoding of instructions, branch resolution where the direction of the branch is the opposite of the direction guessed, or a branch is guessed taken which transfers buffer instruction data association from the main buffers to the recovery buffers.

35. A program product comprising computer readable computer program code to configure and control a computer system having a microprocessor having an instruction cache and instruction registers, wherein the buffer structure is situated between the instruction cache and instruction registers, and interfaces with an asynchronous branch target buffer (BTB) and branch history table (BHT) to define to dynamically alter the output of an index based structured instruction cache to create a buffer structure, and to organize instructions in the form of a trace cache.

36. A program product as defined in claim 35 wherein the dynamic trace buffer structure is configured to comprise horizontal segments whereby data return from the instruction cache fill buffer segments.

37. A program product as defined in claim 36 wherein the dynamic trace buffer structure is configured to comprise horizontal segments whereby each data return from the instruction cache fills a buffer segment.

38. A program product as defined in claim 36 wherein a segment acquires data from one of an instruction cache, a recovery buffer, or a vertical buffer above.

39. A program product as defined in claim 35 wherein the dynamic trace buffer structure is configured to have a vertical direction of a depth at least one layer

40. A program product as defined in claim 39 wherein a segment is adapted to acquire data from the instruction cache, or a vertical buffer directly above the instruction cache.

41. A program product as defined in claim 35 wherein the dynamic trace buffer bidirectionally interacts with a recovery buffer.

42. A program product as defined in claim 41 wherein the dynamic trace buffer is adapted to gate sequential instruction text to the recovery buffer in the case of a predicted taken branch.

43. A program product as defined in claim 35 wherein the dynamic trace buffer structure is adapted to interact with the asynchronous branch target buffer (BTB) and the branch history table (BHT) whereby prior to decoding of the instruction contained in the dynamic trace buffer structure, a branch is flagged in a buffer segment and the target is placed in the sequential buffer.

44. A program product as defined in claim 43 wherein one buffer segment is between the segment containing the beginning instruction text of a branch and the segment containing the instruction text of the target where the instruction length of the predicted starting location is unknown, whereby the branch to span the buffer it originates into the respected sequential buffer.

45. A program product as defined in claim 43 wherein a buffer segment is adapted to contain at most a target of one branch and a future branch located at a point equivalent to either the instruction address or the later of the target of the first branch.

46. A program product as defined in claim 43 wherein the dynamic trace buffer structure supports multiple branch and target combinations.

47. A program product as defined in claim 46 wherein the dynamic trace buffer structure supports multiple branch and target combinations up to the number of buffer segments that are physically designed.

48. A program product as defined in claim 35 wherein a gate is adapted to gate at least a single instruction from a main buffer into an instruction register.

49. A program product as defined in claim 48 wherein the gate is adapted to gate multiple instructions from the main buffers into instruction registers.

50. A program product as defined in claim 35 adapted to initiate a fetch request for a given buffer segment and returning the instruction text to a different buffer segment if the buffer is being emptied via the decoding of instructions, branch resolution where the direction of the branch is the opposite of the direction guessed, or a branch is guessed taken which transfers buffer instruction data association from the main buffers to the recovery buffers.
